(19) United States
(12) Patent Application Publication
(10) Pub. No.: US 2008/0214693 A1
(43) Pub. Date: Sep. 4, 2008

(54) Integrated Coating Material System Based on Uv-A-Curable Solventborne Coating Materials, Process for Producing it, and Use Thereof

(75) Inventors: Bernhard Lettmann, Drensteinfurt (DE); Klaus-Udo Reize, Munster (DE); Egbert Nienhaus, Ascheberg (DE)

Correspondence Address: BASF CORPORATION;Patent Department, 1609 BIDDLE AVENUE, MAIN BUILDING, WYANDOTTE, MI, 48192, US

(73) Assignee: BASF COATINGS AKTIENGESELLSCHAFT, Munster (DE)

(21) Appl. No.: 11/816,779

(22) PCT Filed: Jan. 25, 2006
(86) PCT No.: PCT/EP2006/050555

§ 371 Date: Aug. 21, 2007

(30) Foreign Application Priority Data
Mar. 18, 2005 (DE) 102005012588.3

(51) Int. Cl. C09D 175/04; C08F 2/48

(52) U.S. Cl. 522/174; 427/508

(57) ABSTRACT

An integrated coating material system comprising
(I) at least one solventborne coating material system which is free from hiding pigments and is curable thermally or both thermally and with UV-A radiation and comprises
   (I.1) at least one separate component which is free from isocyanate groups and contains isocyanate-reactive functional groups, and
   (I.2) at least one separate component which is free from isocyanate-reactive functional groups and contains isocyanate groups,
none of components (I.1) and (I.2) or at least one of components (I.1) and/or
   (I.2) containing at least one UV-A-curable constituent; and
(II) at least one separate, UV-A-curable coating material which is free from hiding pigments and isocyanate groups and contains solvent and isocyanate-reactive functional groups;
   the UV-A-curable constituents being present in combination with at least one colorless or substantially colorless photoinitiator having at least one absorption maximum in the wavelength range of λ=300 to 400 nm;
   process for producing it, and use thereof.

The present invention relates to a new integrated coating material system based on UV-A-curable solventborne coating materials. The present invention also relates to a new process for producing an integrated coating material system based on UV-A-curable solventborne coating materials. The present invention further relates to the use of the new integrated coating material system based on UV-A-curable solventborne coating materials and of the integrated coating system based on UV-A-curable solventborne coating materials that is produced with the aid of the new process in automotive refinish.

In automotive refinish, large damage sites are usually treated by removing the damaged parts of the bodywork and refinishing the entire area. However, for instances of minor damage, which are very annoying particularly in the case of new and/or particularly high-value vehicles, such as key scratches or knocks (for example, from the demarcation in a parking lot), for instance, this procedure is very involved and is disproportionate to the size of the damage. Minor damage is therefore sometimes removed preferably with the aid of methods of minor vehicle refinish. These methods are also referred to by those in the art as touch-up or spot repair.

The known spot repair methods, however, have numerous disadvantages and are difficult to implement. For instance, the runout zones of the clearcoat spray mist on the original finish are often too wide, which makes it more difficult to achieve a visual match between refinish and original finish. Additionally, because of the poor adhesion of the refinish clearcoat to the original finish in the runout zones around the damage site, the refinish clearcoat may break away or come off. That produces clearly visible edges which may even run all the way round the refinish clearcoat, which is located directly above the original finish. In that case the overall effect of the refinish, owing to the visually hard transition zones, is that of a “stuck-on patch”.

Attempts have been made to solve the problems of the breaking away or coming off and the difficulty of matching the visual qualities in the runout zones by applying what are called spot blenders over the uncured refinish clearcoat. The purpose of this measure is to produce particularly “soft” transition zones and to prevent the refinish clearcoat coming away in the zones marginal to the original finish.

Substantial advantages have been provided here by the spot repair method known from German patent application DE 100 43 810 A1. Thus it is possible to lower the sanding and/or polishing times by more than 50% as compared with conventional methods. There is no longer any visual difference between the resultant refinishes and the original finishes. The refinish clearcoat is no longer observed to come off or break away in the runout zones. The quality of the refinishes is such that the spot repair method in question can even be used for automotive spot repair of original finishes on the line at the automaker's plant. In view of the high pass rate, considerable economic advantages are achieved by this means.

Nevertheless, the spot blender used in the case of the known spot repair method is not fully capable of being used in spot repair methods which employ clearcoat materials that are curable with actinic radiation, preferably with UV radiation, and in particular with UV-A radiation (on “actinic radiation” cf. German patent application DE 103 16 890 A1, page 6, paragraph [0035]).

International patent application WO 94/11123 discloses a UV-A-curable solventborne composition composed of

6 to 10 parts of polyfunctional melamine acrylate,
5 to 8 parts of polyether acrylate oligomer,
9 to 12 parts of epoxy acrylate,
6 to 10 parts of ethoxylated trimethylolpropane triacrylate,
9 to 12 parts of isodecyl acrylate,
40 to 60 parts of solvent mixture of alcohols, glycol ethers and acetates,
0.6 to 1.2 parts of p-phenylbenzophenone,
0.1 to 0.3 part of polyether-modified dimethylpolysiloxane copolymers, and
4 to 6 parts of polysiloxane polyether copolymer.

The known composition is used for producing scratchproof antifog coats.

German patent applications DE 100 48 849 A1, DE 102 02 565 A1 and DE 103 16 890 A1 disclose solventborne compositions that are curable thermally and with UV-A radiation, i.e., dual-cure compositions, comprising
hydroxyl-containing methacrylate copolymers,
dipentaerythrityl pentaacrylate,
solvents such as butyl acetate, ethoxyethyl propionate, methyl isoamyl ketone and Solventnaphtha®,
Irgacure® 184 from Ciba Spezialitätenchemie (1-hydroxycyclohexyl phenyl ketone; white powder; absorption maxima at λ=240 to 250 nm and 320 to 335 nm)
Lucirin® TPO from BASF Aktiengesellschaft (acylphosphine oxide; yellowish powder; absorption maximum at λ=380 nm),
wetting agents, and
light stabilizers.

These mixtures are used exclusively for preparing clearcoat materials that are curable thermally and with actinic radiation (dual-cure clearcoat materials) and that can also be used as refinish clearcoat materials. The compositions are not used as spot blenders in spot repair methods.

German patent DE 197 09 467 C1 discloses UV-curable, solvent-free compositions containing, for example,
hexafunctional urethane acrylate,
hexanediol diacrylate, and
Irgacure® 184.

One of the uses of these compositions is as refinish clearcoat materials. They cannot be used as spot blenders in spot repair methods.

Dual-cure coating materials prepared from multicomponent systems, especially two-component systems, which include polyisocyanates as curing agents are known from German patent applications DE 103 16 890 A1, DE 103 00 798 A1, DE 102 02 565 A1, DE 100 42 152 A1, DE 102 04 114 A1, DE 100 48 847 A1, DE 100 48 849 A1 or DE 100 48 275 A1 or DE 100 48 670 A1. These coating materials are used in particular as dual-cure clearcoat materials for producing multicoat color and/or effect paint systems in the OEM sector. These multicoat color and/or effect paint systems have outstanding performance properties.

The known dual-cure coating materials can also be used as refinish clearcoat materials. In this utility, however, they exhibit certain disadvantages which do not occur in the case of the aforementioned OEM application. Thus, in the refinishing of multicoat paint systems which comprise basecoats containing platelet-shaped effect pigments, especially aluminum effect pigments, instances of hazing or matting occur in the refinish. The reason for these defects is that, in contrast to the OEM application, the refinish basecoat films can be dried only at not more than 60° C., and so they are dissolved to a certain extent by the subsequently applied refinish clearcoat materials. In the course of subsequent curing of the refinish clearcoat films with actinic radiation, preferably UV radiation, and in particular UV-A radiation, the refinish clearcoat films undergo contraction (polymerization shrinkage). As a result, the platelet-shaped effect pigments located in the region of the surface of the refinish basecoat films are “entrained” by the contracting clearcoat films, thereby resulting in said paint defects.

German patent application DE 100 48 670 A1 discloses an integrated coating material system which comprises
a coating material system for preparing a thermally curable multicomponent surfacer, comprising (a) a component which is free from isocyanate groups and contains isocyanate-reactive functional groups and a filler (b), a component which is free from isocyanate-reactive functional groups and contains polyisocyanates, and (c) a diluent,
a coating material system for preparing a thermally curable multicomponent topcoat material, comprising (a) a component which is free from isocyanate groups and contains isocyanate-reactive functional groups and at least one pigment, (b) a component which is free from isocyanate-reactive functional groups and contains polyisocyanates, and (c) a diluent, and
at least one coating material system for preparing a multicomponent clearcoat material which is curable thermally and with actinic radiation, comprising (a) a component which is free from isocyanate groups and contains isocyanate-reactive functional groups, (b) a component which is free from isocyanate-reactive functional groups and contains polyisocyanates, and (c) a diluent.

The coating material systems are consistently prepared using the same polyisocyanates and the same diluents, thereby giving technical and economic advantages. Nevertheless, this known coating material system is unable to solve the above-outlined problems of the “entrainment” of platelet-shaped effect pigments at the boundary between refinish clearcoat film and refinish basecoat film. Moreover, the known coating material system is not designed such that it can be used in spot repair methods and such that in that case the clearcoat film is to be cured using UV-A radiation. The problems which may occur in the runout zones of refinishes are not addressed at all in German patent application DE 100 48 670 A1.

It is an object of the present invention to provide a new integrated coating material system based on UV-A-curable coating materials.

The new integrated coating material system ought to be easy to chose with very good reproducibility and ought to be able to be stored and transported to users, especially paint shops, without any problems.

In particular the system ought to be outstandingly suitable for producing automotive refinishes that are free from paint defects such as haze and matting.

In particular, however, it ought to be outstandingly suitable for automotive spot repair.

In these utilities the new integrated coating material system ought to solve the problems recited above that are associated with the use of the known spot blenders in spot repair methods and with the use of the known dual-cure clearcoat materials.

This means that the new integrated coating material system ought to make it possible to carry out, in particular, spot repair methods which provide refinishes which can be sanded and/or polished within a very short time, which no longer differ visually from the original finish, which no longer exhibit any coming off or breaking away in the runout zones, and which are of such high quality that they can be used even for automotive spot repair of original finishes on the line.

Accordingly we have found the new integrated coating material system comprising
(I) at least one solventborne coating material system which is free from hiding pigments and is curable thermally or both thermally and with UV-A radiation and comprises
   (I.1) at least one separate component which is free from isocyanate groups and contains isocyanate-reactive functional groups, and
   (I.2) at least one separate component which is free from isocyanate-reactive functional groups and contains isocyanate groups,
none of components (I.1) and (I.2) or at least one of components (I.1) and/or
   (I.2) containing at least one UV-A-curable constituent;
      and
(II) at least one separate, UV-A-curable coating material which is free from hiding pigments and isocyanate groups and contains solvent and isocyanate-reactive functional groups;
   the UV-A-curable constituents being present in combination with at least one colorless or substantially colorless photoinitiator having at least one absorption maximum in the wavelength range of λ=300 to 400 nm;
   this system being referred to below as the “coating system of the invention”.

Also found has been the new process for producing the coating material system of the invention, which comprises preparing components (I.1) and (I.2) of the coating material system (I) and also the coating material (II) separately from one another by mixing their respective constituents and homogenizing the resultant mixtures, and thereafter storing the resulting components (I.1) and (I.2) of the coating material system (I) and the coating material (II) separately from one another until their further use.

The new process for producing the coating material system of the invention is referred to below as the “process of the invention”.

Found not least has been the new use of the coating material system of the invention and of the coating material system of the invention produced by means of the process of the invention in automotive refinish for refinishing damage sites in multicoat color and/or effect paint systems, this being referred to below as “use in accordance with the invention”.

Further subject matter of the invention will emerge from the description.

In the light of the prior art it was surprising and unforeseeable for the skilled worker that the object on which the present invention was based could be achieved by means of the composition of the invention, the process of the invention, and the use in accordance with the invention.

In particular it was surprising that the coating material system of the invention was producible easily and with very good reproducibility and could be stored and transported to users, especially paintshops, without problems.

In particular the system was outstandingly suitable for producing automotive refinishes which were free from paint defects such as haze and matting.

In particular, however, it was outstandingly suitable for minor automotive spot repair.

In these utilities the new integrated coating material system was able fully to solve the above-recited problems associated with the use of the known spot blenders in spot repair methods and with the use of the known dual-cure clearcoat materials.

Hence the new integrated coating material system made it possible to carry out, in particular, spot repair methods which gave refinishes that could be sanded and/or polished within a short time, that no longer differed visually from the original finish, that no longer exhibited any coming off or breaking away in the runout zones, and that were of a quality such that they could be used even for automotive spot repair of original finishes on the line.

The coating material system of the invention comprises
(I) at least one, especially one, solventborne coating material system which is free from hiding pigments and is curable thermally or both thermally and with UV-A radiation and comprises
   (I.1) at least one, especially one, separate component which is free from isocyanate groups and contains isocyanate-reactive functional groups, and
   (I.2) at least one, especially one, separate component which is free from isocyanate-reactive functional groups and contains isocyanate groups,
   none of components (I.1) and (I.2) or at least one of components (I.1) and/or (I.2), especially component (I.1), containing at least one UV-A-curable constituent;
      and
(II) at least one, especially one, separate, UV-A-curable coating material which is free from hiding pigments and isocyanate groups and contains solvent and isocyanate-reactive functional groups;
   the UV-A-curable constituents being present in combination with at least one colorless or substantially colorless photoinitiator having at least one absorption maximum in the wavelength range of λ=300 to 400 nm, preferably with at least two photoinitiators.

In one preferred embodiment the coating material system of the invention is composed of
at least one, especially one, coating material system (I) in which none of components (I.1) and (I.2) contains a UV-A-curable constituent, and
at least one, especially one, coating material (II).

In another preferred embodiment the coating material system of the invention is composed of
at least one, especially one, coating material system (I) in which at least one of components (I.1), in particular one component (I.1), contains at least one UV-A-curable constituent, and
at least one, especially one, coating material (II).

In a third preferred embodiment the coating material system of the invention is composed of
at least one, especially one, coating material system (I) in which none of components (I.1) and (I.2) contains a UV-A-curable constituent,
at least one, especially one, coating material system (I) in which at least one of the components (I.1), in particular one component (I.1), contains a UV-A-curable constituent, and
at least one, especially one, coating material (II).

For the coating material system of the invention it is of advantage if constituents which have the same technical effect, such as, for example, the respective UV-A-activable and/or -curable constituents, photoinitiators, organic solvents, light stabilizers or wetting agents, are physically identical in the coating material system (I) and the coating material (II).

For the coating material system of the invention in the third preferred embodiment it is additionally of particular advantage if the polyisocyanates present in the two coating material systems (I) are physically identical.

The first essential constituent of the coating material system of the invention is the coating material system (I).

The coating material system (I) is free from hiding pigments, i.e., the coatings produced therefrom are transparent or clear. Accordingly the coating material system (I) can comprise nonhiding pigments, such as transparent fillers or nanoparticles, especially nanoparticles, or molecularly dispersely distributed dyes.

The coating material system (I) may be exclusively thermally curable. In that case the thermal curing takes place via the isocyanate-reactive functional groups of component (I.1) and the isocyanate groups of component (I.2).

Examples of suitable isocyanate-reactive functional groups are hydroxyl groups, thiol groups and primary and secondary amino groups, especially hydroxyl groups.

Examples of suitable constituents for the construction of component (I.1), which contain the isocyanate-reactive functional groups, are known for example from German patent application DE 100 48 670 A1, page 3, paragraph [0017], to page 4, paragraph* [0028], or from German patent application DE 103 16 890 A1, page 9, paragraph [0061], to page 13, paragraph [0090].

Additionally component (I.1) may comprise the additives described in German patent application DE 103 16 890 A1, page 13, paragraphs [0092] and [0093], and in German patent application DE 100 48 670 A1, page 4, paragraphs [0038] and [0039], and page 5, paragraphs [0041] to [0042] and [0045] to [0056].

The isocyanate groups of component (I.2) are present preferably in polyisocyanates, especially conventional paint polyisocyanates. Examples of suitable polyisocyanates are described in German patent application DE 100 48 670 A1, page 5, paragraph [0058], to page 6, paragraph [0064], or in German patent application DE 103 16 890 A1, page 14, paragraph [0105], to page 15, paragraph [0106], and page 15, paragraphs [0108] and [0109].

The coating material system (I) may be curable thermally and with UV-A radiation, i.e., may be a dual-cure system.

As is known, UV-A-radiation is UV radiation with a wavelength range of λ=300 to 400 nm. Suitable light sources for UV-A-radiation are customary and known and are described for example in German patent application DE 103 16 890 A1, page 17, paragraphs [0128] to [0130], or in international patent application WO 94/11123, page 2, line 35, to page 3, line 6, page 3, lines 10 to 15, and page 8, lines 1 to 14.

In order to adjust the UV-A curability it is preferred to add to component (I.1) of the coating material system (I) at least one constituent which is UV-A-activable and thereby-curable.

Suitable UV-A-curable constituents include basically all compounds such as are described for example in German patent application DE 100 48 670 A1, page 4, paragraphs [0029] to [0036].

Preferably the UV-A-curable constituents are selected from the group consisting of
monomers (a1) containing at least three, preferably at least four, more preferably at least five, and in particular five UV-A-curable reactive functional groups and at least one, especially one, isocyanate-reactive functional group and
mixtures (a2) of
   monomers (a21) that are free from isocyanate-reactive functional groups and contain at least two, preferably at least three, more preferably at least four, and in particular four UV-A-curable reactive functional groups, and
   monomers (a22) that contain at least two, preferably at least three, and in particular three UV-A-curable reactive functional groups and also at least one and in particular one isocyanate-reactive functional group.

Examples of suitable groups that are UV-A-activable and therefore -curable are the reactive functional groups described in German patent application DE 103 16 890 A1, page 6, paragraphs [0035] and [0039] to [0041]. In particular, acrylate groups are used.

Examples of suitable isocyanate-reactive functional groups are those described above.

One example of a particularly suitable monomer (a1) is dipentaerythrityl pentaacrylate.

One example of a particularly suitable mixture (a2) is the mixture of pentaerythrityl tetraacrylate (a21) and pentaerythrityl triacrylate (a22).

The second essential constituent of the coating material system of the invention is the coating material (II).

The coating material (II) is free from hiding pigments and isocyanate groups. It contains isocyanate-reactive functional group, as described above. It is curable with UV-A radiation. In its composition, therefore, it is equivalent to component (I.1) of the coating material system (I), except that the coating material (II) contains the isocyanate-reactive functional groups preferably exclusively in the above-described UV-A-curable constituents and not in one of the above-described constituents that contains isocyanate-reactive functional groups.

For the coating material system of the invention it is essential that the UV-A-curable constituents are used in combination with at least one colorless or substantially colorless photoinitiator having at least one absorption maximum in the wavelength range of λ=300 to 400, preferably 320 to 390 and in particular 340 to 380 nm.

The photoinitiators are colorless. This means that their masstone color is white (cf. Römpp Lexikon Lacke und Druckfarben, Georg Thieme Verlag, Stuttgart N.Y., 1998, “masstone colors” and “achromatic point”).

It is also possible, however, for the photoinitiators to be substantially colorless. This means that they have an intrinsic color of low chromaticity, such as a very pale yellow shade, for example, but one which, at the concentrations at which the photoinitiators are employed, produces no discoloration of the coating material systems of the invention and of the refinishes produced with them.

Suitable photoinitiators are all conventional photoinitiators, as described for example in German patent application DE 103 16 890 A1, page 6, paragraphs [0035] and [0036], or in Römpp Lexikon Lacke und Druckfarben, Georg Thieme Verlag, Stuttgart, N.Y., 1998, “photoinitiators”, provided they have the profile of properties specified above.

Examples of photoinitiators which are especially suitable are 1-hydroxycyclohexyl phenyl ketone (Irgacure® 184 from Ciba Spezialitätenchemie), 2,2-dimethoxy-1,2-diphenylethan-1-one (Irgacure® 651 from Ciba Spezialitätenchemie) and diphenyl(2,4,6-trimethylbenzoyl)phosphine oxide (Darocur® 4265 from Ciba Spezialitätenchemie), particularly mixtures of Irgacure® 184 and Irgacure® 651.

The photoinitiators are used in the conventional amounts recommended in the state of the art.

In one particularly preferred embodiment of the coating material system of the invention the coating material (II) is composed of
(A) 1% to 50% by weight of at least one of the above-described UV-A-curable constituents;

(B) 0.01% to 10%, preferably 0.05% to 5% and in particular 0.05% to 3% by weight of at least one of the above-described photoinitiators;
(C) 10% to 70% by weight of at least one alkyl and/or cycloalkyl acetate having 3 to 10 carbon atoms in the alkyl radical and/or in the cycloalkyl radical, as described below;
(D) 10% to 70% by weight of at least one alkoxyalkyl, alkoxycycloalkyl, cycloalkoxyalkyl and/or cycloalkoxycycloalkyl acetate, as described below;
(E) 0.01% to 5% by weight of at least one constituent that lowers the interfacial tension, as described below;
(F) 0 to 50% by weight of at least one alkylaromatic having at least two alkyl radicals having 1 to 6 carbon atoms in the molecule, as described below; and
(G) 0 to 50% by weight of at least one additive other than constituents (A) to (F), as described below.

Constituent (C) is selected from the group consisting of alkyl and/or cycloalkyl acetates having 3 to 10 carbon atoms in the alkyl radical and/or in the cycloalkyl radical. Examples of suitable constituents (C) are known from German patent application DE 100 43 810 A1, column 3, paragraphs [0016] to [0018]. Butyl acetate in particular is used.

Constituent (C) is present in the coating material (II) in an amount of 10% to 70%, preferably 15% to 50% and in particular 20% to 45% by weight.

Constituent (D) is selected from the group consisting of alkoxyalkyl, alkoxycycloalkyl, cycloalkoxyalkyl and/or cycloalkoxycycloalkyl acetate. Examples of suitable constituents (D) are known from German patent application DE 100 43 810 A1, column 3, paragraph [0020], to column 4, paragraph [0025]. 1-Methoxypropyl acetate in particular is used.

Constituent (D) is present in the coating material (II) in an amount of 10% to 70%, preferably 15% to 50% and in particular 20% to 45% by weight.

Constituent (E) is at least one compound that lowers the interfacial tension, in particular at least one wetting agent (cf. in this respect Römpp Lexikon Lacke und Druckfarben, Georg Thieme Verlag, Stuttgart, N.Y., 1998, “wetting agents” and “flow control assistants”). Examples of suitable wetting agents are known from German patent application DE 100 43 810 A1, column 4, paragraph [0032]. Polyether-modified methylpolysiloxanes in particular are used. They are sold under the brand name Baysilone® OL 44 by the company Borchers.

Constituent (E) is present in the coating material (II) in an amount of 0.001% to 5%, preferably 0.005% to 2% and in particular 0.05% to 1% by weight.

The coating material (II) may contain up to 50% by weight of constituent (F). Constituent (F) is selected from the group consisting of alkylaromatics having at least two alkyl radicals having 1 to 6 carbon atoms in the molecule. Examples of suitable constituents (F) are known from German patent application DE 100 43 810 A1, column 4, paragraph [0027]. Xylene in particular is used. Preferably constituent (F) is present in the composition of the invention in an amount of 5% to 50%, more preferably 10% to 30% and in particular 10% to 25% by weight.

The coating material (II) may further contain up to 50% by weight of at least one additive (G) other than constituents (A) to (F). The additives (G) are preferably selected from the group consisting of light stabilizers, such as UV absorbers and reversible free-radical scavengers (HALS); antioxidants; customary paint solvents; biocides; and thermal crosslinking catalysts. The amount of additive (G) used may therefore vary very widely from one additive (G) to another.

It is preferred to use thermal crosslinking catalysts (G), more preferably catalysts (G) of the reaction of isocyanate groups with isocyanate-reactive functional groups, and very preferably lithium, zinc, bismuth and/or tin compounds, as described for example in German patent application 100 48 670 A1, page 5, paragraph [0043], but in particular dibutyltin dilaurate.

This catalyst (G) is preferably present in the coating material (II) in an amount of 0.01% to 2%, more preferably 0.03% to 1% and in particular 0.05% to 0.5% by weight.

This catalyst (G) can also be present in these amounts in component (I.1) of the coating material system (I), in which case the percentages are based on component (I.1).

Preferably the coating material system of the invention is produced by means of the process of the invention. In the process of the invention components (I.1) and (I.2) of the coating material system (I) and also the coating material (II) are prepared separately from one another by mixing their respective, above-described constituents and homogenizing the resultant mixtures preferably in the absence of actinic radiation, after which the resulting components (I.1) and (I.2) of the coating material system (I) and the coating material (II) are stored separately from one another, preferably in the absence of actinic radiation, until further use. Preference is given in this context to using the conventional mixing techniques and apparatus such as stirred tanks, agitator mills, extruders, compounders, Ultraturrax, inline dissolvers, static mixers, micromixers, toothed-wheel dispersers, pressure-release nozzles and/or microfluidizers.

The coating material system of the invention can per se be put to numerous end uses. Preferably it is used for producing multicoat color and/or effect paint systems, both for OEM and for automotive refinish, preferably automotive refinish, especially automotive spot repair.

Preferably in this context the coating material system (I) is used for preparing clearcoat materials, especially refinish clearcoat materials.

Within the context of the coating material system of the invention, the coating material (II) can per se serve for numerous end uses. In particular, however, in the context of use in accordance with the invention, it is used as a spot blender in spot repair methods or is used for preparing such a spot blender.

If the coating material (II) is used for preparing spot blenders, this is preferably done by mixing the coating material (II) with one of the above-described dual-cure refinish clearcoat materials, prepared from the coating material system (I) and homogenizing the resulting mixture, which can be used with advantage as a spot blender in the spot repair method of the invention. It is preferred in this context to use the coating material system (I) from which the particular dual-cure refinish clearcoat material used is prepared.

The spot repair method of the invention encompasses the following steps:
(1) cleaning the damage site and its surroundings,
(2) sanding and recleaning the damage site,
(3) if desired, filling, sanding and cleaning the damage site,
(4) applying a surfacer and flashing off the resultant surfacer film, or alternatively curing the surfacer film and sanding and cleaning the resultant surfacer coat,
(5) applying a basecoat material to the surfacer film (4) or surfacer coat (4), flashing off the resultant basecoat film, and removing any overspray,
(6) applying at least one of the above-described dual-cure refinish clearcoat materials, prepared from the coating material system (I), wet-on-wet to the basecoat film (5) and flashing off the resultant refinish clearcoat film,
(7) applying the above-described coating material (II) as a spot blender, or applying a spot blender prepared from the coating material (II) and a refinish clearcoat material obtained from the coating material system (I), to the refinish clearcoat film (6), and
(8) jointly curing the applied films (5), (6) and (7) and also, where appropriate, (4) with UV-A radiation and also, where appropriate, thermally.

In one embodiment of the spot repair method of the invention that can be used to solve specific problems in step (6)
(6.1) first of all at least one of the above-described refinish clearcoat materials, prepared from the coating material system (I) in which none of components (I.1) and (I.2) contains a UV-A-curable constituent, is applied to the basecoat film (5), to give at least one thermally curable refinish clearcoat film, and
(6.2) at least one of the above-described refinish clearcoat materials, prepared from the coating material system (I) in which at least one of the components (I.1) and/or (I.2) contains a UV-A-curable constituent, is applied to the refinish clearcoat film (6.1), to give at least one refinish clearcoat film which is curable thermally and with actinic radiation.

For the spot repair method of the invention it is advantageous for the basecoat material (5) to be applied hidingly by pneumatic application using a spray gun from the outside, i.e., from the original finish, inward, i.e., toward the center of the damage site.

For the pneumatic application of the coating materials it is possible to use spray guns that are conventional per se. In accordance with the invention, however, it is of advantage to use smaller spray guns than the conventional spray guns. Small-size spray guns of this kind are available from the company SATA, Kornwestheim, under the trade name SATA minijet 2 HVLP SR (spot repair).

For the cleaning and sanding it is possible to use the cleaning equipment and cleaning fluids and also sanding and/or polishing equipment that is normally used for automotive refinishing.

For the filling (3) it is possible to use customary and known knifing fillers, especially UV-curable knifing fillers, such as those from the company BASF Coatings AG.

Suitable surfacers (4) include conventional aqueous and solventborne surfacers as described for example in patents and patent applications U.S. Pat. No. 4,537,926 A, EP 0 529 335 A 1, EP 0 595 186 A 1, EP 0 639 660 A 1, DE 44 38 504 A 1, DE 43 37 961 A 1, WO 89/10387, U.S. Pat. No. 4,450,200 A, U.S. Pat. No. 4,614,683 A or WO 94/26827. Also suitable are UV-curable surfacers (4).

The surfacers (4) are commercially customary products which are sold for example by BASF Coatings AG under the brand name Glasurit® 1K-Grundfüller 76-71 [one-component primer-surfacer].

Examples of suitable solventborne or aqueous basecoat materials (5) are known from patent applications EP 0 089 497 A 1, EP 0 256 540 A 1, EP 0 260 447 A 1, EP 0 297 576 A 1, WO 96/12747, EP 0 523 610 A 1, EP 0 228 003 A 1, EP 0 397 806 A 1, EP 0 574 417 A 1, EP 0 531 510 A 1, EP 0 581 211 A 1, EP 0 708 788 A 1, EP 0 593 454 A 1, DE-A-43 28 092 A 1, EP 0 299 148 A 1, EP 0 394 737 A 1, EP 0 590 484 A 1, EP 0 234 362 A 1, EP 0 234 361 A 1, EP 0 543 817 A 1, WO 95/14721, EP 0 521 928 A 1, EP 0 522 420 A 1, EP 0 522 419 A 1, EP 0 649 865 A 1, EP 0 536 712 A 1, EP 0 596 460 A 1, EP 0 596 461 A 1, EP 0 584 818 A 1, EP 0 669 356 A 1, EP 0 634 431 A 1, EP 0 678 536 A 1, EP 0 354 261 A 1, EP 0 424 705 A 1, WO 97/49745, WO 97/49747, EP 0 401 565 A 1 or EP 0 817 684, column 5, lines 31 to 45. It is also possible to use the basecoat materials (5) on the basis of the mixer system described in European patent application EP 0 578 645 A 1.

The basecoat materials are commercially customary products which are sold for example by BASF Coatings AG under the brand names Glasurit® topcoat 55 line with Glasurit® standardizing additive 352-91 or Glasurit® topcoat 90 line with Glasurit® standardizing additive 93-E 3 and Glasurit® blender 90-M5 in accordance with European patent application EP 0 578 645 A 1.

The thermal curing of the coating materials that are applied in the spot repair method of the invention has no special features but instead takes place using conventional equipment, such as fan heaters and radiant heaters which emit near and far infrared. The temperatures employed and the duration of heating are guided by the requirements of the case in hand, in particular by the reactivity of the thermally curable constituents, and can be selected and adjusted easily by the skilled worker on the basis of his or her general art knowledge and skill in the art.

The curing of the coating materials applied in the spot repair method of the invention with UV-A radiation likewise has no special features but instead takes place with the conventional light sources as described above. Shadow zones can be exposed using aluminum foils as mirrors or reflectors. The duration of exposure and the irradiated dose are guided by the requirements of the case in hand, in particular by the reactivity of the UV-A-curable constituents, and can be selected and adjusted easily by the skilled worker on the basis of his or her general art knowledge and skill in the art.

The UV-A light sources may have been provided in conventional fashion with filters, so that the coating materials applied in the spot repair method of the invention can be cured alternately with IR radiation, i.e., thermally, and with UV-A radiation.

The spot repair method of the invention is suitable in particular for the spot repair of damage areas up to 4 to 5 cm in diameter. The damage site should be free from deformations such as dents, scratches or stonechips. Spot repair on vertical surfaces is particularly advisable. In the case of horizontal surfaces, the spot repair method is employed advantageously in the vicinity of edges (distance up to 15 cm).

The use in accordance with the invention and the spot repair method of the invention give refinishes which can be sanded and/or polished within a very short time, which no longer stand out visually from the original finish, which no longer show any coming off or breaking away in the runout zones, and which are of a quality such that they can even be used for automotive spot repair of original finishes on the line.

A completely surprising outcome in this case is that by means of the use in accordance with the invention and of the spot repair method of the invention it is possible completely to avoid haze, matting and similar paint defects of refinish basecoats comprising platelet-shaped aluminum effect pigments.

A further very particular advantage of the coating material system of the invention, of the process of the invention and of the use in accordance with the invention, moreover, particularly of the spot repair method of the invention, is that the UV-A-curable constituents can be used in the refinish clearcoat materials in comparatively small amounts, while nevertheless achieving outstanding outcomes in combination with the coating material (II).

### EXAMPLES

### Example 1

### The Production of a Coating Material System

1.1 The production of the Coating Material System (I) and of a Refinish Clearcoat Material Therefrom

### 1.1.1 Component (I.1)

Component (I.1) of the coating material system (I) was produced in a suitable stirred vessel in the absence of actinic radiation by mixing 45 parts by weight of the thermally curable methacrylate copolymer known from German patent application DE 100 48 670 A1, preparation example 1, page 10, lines 8 to 22, 35 parts by weight of dipentaerythrityl pentaacrylate, 8 parts by weight of butyl acetate, 7.5 parts by weight of ethyl ethoxypropionate, 0.2 part by weight of Byk® 325 and 0.5 part by weight of Byk® 358 (both standard commercial coatings additives from Byk Chemie), 0.6 part by weight of dibutyltin dilaurate (10 percent strength), 1.0 part by weight of Tinuvin® 292 and 1.0 part by weight of Tinuvin® 400 (both standard commercial light stabilizers from Ciba Spezialitätenchemie), 0.8 part by weight of 1-hydroxycyclohexyl phenyl ketone (Irgacure® 184 from Ciba Spezialitätenchemie) and 0.4 part by weight of 2,2-dimethoxy-1,2-diphenylethan-1-one (Irgacure® 651 from Ciba Spezialitätenchemie) and homogenizing the resultant mixture.

### 1.1.2 Component (1.2)

As component (I.2) use was made of the standard commercial topcoat curing agent Glasurit® VOC-Decklack-Härter kurz 929-31 from BASF Coatings AG, on the basis of the standard commercial polyisocyanate Desmodur® N 3600 from Bayer AG.

### 1.1.3 Diluent

The diluent used for the coating material system (I) was the standard commercial standardizing additive Glasurit® Einstellzusatz 352-91 from BASF Coatings AG.

The above-described components of coating material system (I) were stable on storage in the absence of actinic radiation and could be transported to paintshops without problems. On the basis of their advantageous viscosity they could be mixed by hand without great expenditure on apparatus.

### 1.1.4 Refinish Clearcoat

The refinish clearcoat material was prepared by mixing the components (I.1) and (I.2) in a ratio of 2:1 and thereafter adding 10% of diluent to the mixture.

The resultant refinish clearcoat material had an outstanding pot life, outstanding application properties and an advantageously rapid drying time to the dust-dry state.

### 1.2 The Preparation of Coating Material (II)

In a suitable stirred vessel and in the absence of actinic radiation 36 parts by weight of butyl acetate, 36 parts by weight of 1-methoxypropyl acetate, 16.4 parts by weight of xylene, 0.3 part by weight of wetting agent (Baysilone® OL 44 from Borchers, 10 percent strength), 10 parts by weight of dipentaerythrityl pentaacrylate, 0.1 part by weight of 2,2-dimethoxy-1,2-diphenylethan-1-one (Irgacure® 651 from Ciba Spezialitätenchemie), 0.2 part by weight of 1-hydroxycyclohexyl phenyl ketone (Irgacure® 184 from Ciba Spezialitätenchemie) and 1.0 part by weight of dibutyltin dilaurate (10 percent strength) were mixed with one another and the resulting mixture was homogenized.

The coating material (II) could without problems be stored in the absence of actinic radiation and transported to users. It was outstandingly suitable as a spot blender for spot repair methods.

### Example 2

### Automotive Spot Repair

### Paint Damage:

The damage site for repair was a 4 to 5 cm long scratch in an auto door with silver metallic paint, the scratch having been caused by a key and extending in part down to the substrate.

### Actions:

The equipment, materials and steps indicated below were employed in the order stated.

### Cleaning:

1. spray can with Teroson® intensive screen cleaner

2. finish control spray 55535 from 3M

3. spray bottle with nitrodiluent M600 from Akzo

4. Kimberley Clark Classic® cleaning cloths

### Sanding:

Lackpfeile® painting file
Schleifblüte® P 1500 sanding pad from 3M

### Filling:

knifing filler from BASF Coatings AG
flash-off time: 10 minutes/20° C.
sanding: wet (spray bottle) with Schleifblüte® P 1000 sanding pad from 3M

### Masking Off:

paper and masking tape from 3M

### Basecoat:

Glasurit® two-coat topcoat 90 line with silver metallic effect from BASF Coatings AG
spray gun: SATA minijet 2 HVLP SR; spray pressure: 1.5 bar
damage site sprayed hidingly from the outside toward the center and running out extensively into the surrounding area
flashing off: two to three minutes after each spray pass
wiping with dust-binding cloth

### Refinish Clearcoat:

refinish clearcoat as per example 1, item 1.1.4
spray gun: SATA minijet 2 HVLP SR; spray pressure: 1.5 bar
damage site sprayed from the outside toward the center and running out extensively in two spray passes into the surrounding area
flashing off: two to three minutes after each spray pass

### Spot Blender:

coating material (II) as per example 1, item 1.2
spray gun: SATA minijet 2 HVLP SR; spray pressure: 1.5 bar
spot blender sprayed over the runout zones of the clearcoat

### Curing:

In succession:
1. thermal cure with shortwave infrared radiation for three minutes
2. radiation cure with UV-A radiation (dose: 4.000 mJ/cm²)

Immediately thereafter, the resultant refinish had very good polishability and was matched outstandingly in visual and mechanical terms to the original finish. No haze, matting or other paint defects were observed.

1. An integrated coating material system comprising
(I) at least one solventborne coating material system which is free from hiding pigments and is curable thermally or both thermally and with UV-A radiation and comprises
(I.1) at least one first component which is free from isocyanate groups and comprises isocyanate-reactive functional groups, and
(I.2) at least one second component which is free from isocyanate-reactive functional groups and comprises isocyanate groups,
(II) at least one separate, UV-A-curable coating material which is free from hiding pigments and isocyanate groups and comprises solvent, at least one UV-A-curable constituent, and isocyanate-reactive functional groups;
wherein the at least one UV-A-curable constituents is present in combination with at least one colorless or substantially colorless photoinitiator having at least one absorption maximum in the wavelength range of λ=300 to 400 nm.

2. The integrated coating material system of claim 1, wherein the integrated coating material system comprises
at least one solventborne coating material system (I) in which none of components (I.1) and (I.2) contains-comprise a UV-A-curable constituent, and
at least one UV-A curable coating material (II).

3. The integrated coating material system of claim 1, wherein the integrated coating material system comprises
at least one solventborne coating material system (I) in which at least one of components (I.1) and (I.2) comprises at least one UV-A-curable constituent, and
at least one UV-A-curable coating material (II).

4. The integrated coating material system of claim 1, wherein the integrated coating material system comprises
a first at least one solventborne coating material system (I) in which none of components (I.1) and, (I.2) comprise a UV-A-curable constituent,
a second at least one solventborne coating material system (I) in which at least one of the components (I.1) and (I.2) comprise a UV-A-curable constituent, and
at least one UV-A-curable coating material (II).

5. The integrated coating material system of claim 1, wherein the at least one UV-A-curable constituent is selected from the group consisting of monomers (a1) comprising at least three UV-A-curable reactive functional groups and at least one isocyanate-reactive functional group and mixtures (a2) of monomers (a21) that are free from isocyanate-reactive functional groups and comprise at least two UV-A-curable reactive functional groups, and monomers (a22) that comprise at least two UV-A-curable reactive functional groups and at least one isocyanate-reactive functional group.

6. The integrated coating material system of claim 5, wherein component (I.1) and the coating material (II) comprise the same UV-A-curable constituents.

7. The integrated coating material system of claim 5, wherein the monomer (a1) comprises at least four UV-A-curable reactive functional groups.

8. The integrated coating material system of claim 5, wherein the monomer (a21) comprises at least three UV-A-curable reactive functional groups.

9. The integrated coating material system of claim 5, wherein the monomer (a22) comprises at least three UV-A-curable reactive functional groups.

10. The integrated coating material system of claim 1, wherein the photoinitiator has at least one absorption maximum in the wavelength range of λ=320 to 390 nm.

11. The integrated coating material system of claim 5, wherein the UV-A-curable reactive functional groups are acrylate groups.

12. The integrated coating material system of claim 1, wherein the isocyanate-reactive functional groups are hydroxyl groups.

13. A process for producing the integrated coating material system of claim 1, comprising preparing component (I.1) of the solventborne coating material system (I) by mixing the constituents and homogenizing the resultant mixtures; preparing component (I.2) of the solventborne coating material system (I) by mixing the constituents and homogenizing the resultant mixture; preparing the UV-A-curable coating material (II) by mixing the constituents and homogenizing the resultant mixture; and thereafter storing the resulting components (I.1) and (I.2) of the solventborne coating material system (I) and the UV-A-curable coating material (II) separately from one another until their further use.

14. The process of claim 13, carried out in the absence of actinic radiation.

15. A use of the integrated coating material system claim 1 in automotive refinish for repairing damage sites in multicoat color and/or effect paint systems.

16. The use of claim 15, wherein the integrated coating material system is used in automotive spot repair.

17. The use of claim 15, wherein the solventborne coating material system (I) is used for preparing a refinish clearcoat material.

18. The use of claim 15, wherein the UV-A-curable coating material (II) is used as, or, to prepare, a spot blender.

19. The use of claim 18, wherein the UV-A-curable coating material (II) and the solventborne coating material system (I) are combined, and thereafter the resulting mixture is used as a spot blender.

20. The use of claim 15, wherein the use encompasses the following steps:
(1) cleaning the damage site and its surroundings,
(2) sanding and recleaning the damage site,
(3) optionally filling, sanding and cleaning the damage site,
(4) applying a surfacer and flashing off the resultant surfacer film, or alternatively curing the surfacer film and sanding and cleaning the resultant surfacer coat,
(5) applying a basecoat material to the surfacer film (4) or surfacer coat (4), flashing off the resultant basecoat film, and removing any overspray,
(6) applying, at least once, the solventborne coating material system (I) of claim 1, wet-on-wet to the basecoat film (5) and flashing off the resultant refinish clearcoat film,
(7) applying the UV-A-curable coating material (II) claim 1 as a spot blender to the refinish clearcoat film (6), and
(8) jointly curing the applied films (5), (6) and (7) and optionally (4) with UV-A radiation or UV-A radiation and heat.

21. (canceled)
